(19) United States
(12) Patent Application Publication
(10) Pub. No.: US 2025/0098715 A1
(43) Pub. Date: Mar. 27, 2025

(54) METHOD FOR PREPARING OAT-BASED CONDIMENTS

(71) Applicant: Oy Karl Fazer Ab, Vantaa (FI)

(72) Inventors: Niko Nurmi, Helsinki (FI); Miia Viinamäki, Helsinki (FI); Jussi Loponen, Helsinki (FI)

(21) Appl. No.: 18/832,519

(22) PCT Filed: Jan. 23, 2023
(86) PCT No.: PCT/FI2023/050048

§ 371 Date: Jul. 24, 2024

(30) Foreign Application Priority Data
Jan. 24, 2022 (FI) 20225052

(51) Int. Cl. A23L 7/104; A23L 23/00

(52) U.S. Cl. CPC A23L 7/107; A23L 23/00; C12Y 305/01002

(57) ABSTRACT

The present invention relates to a method for preparing oat-based savoury condiments, to oat-based condiments obtained by said method, and to the use of said oat-based condiments as such or as intermediates in the production of other food products. The method for preparing the oat-based condiments includes a step of subjecting an aqueous oat suspension to least one of high-pressure homogenization, microfluidization and wet milling, and to enzymatic hydrolysis.

### FIELD

The present invention relates to a method for preparing oat-based savoury condiments, to oat-based condiments obtained by said method, and to the use of said oat-based condiments as such or as intermediates in the production of other food products. The method for preparing the oat-based condiments includes a step of subjecting an aqueous oat suspension to at least one of high-pressure homogenization, microfluidization and wet milling, and to enzymatic hydrolysis.

### BACKGROUND

Oat (Avena sativa) is a species of cereal grain associated with various health benefits. The beneficial effects of oats are linked to reduction of blood cholesterol levels, reduction of blood glucose rise, and gut health. Compared to other cereals, oat contains more fat, protein, and soluble fibre, and is especially rich in β-glucan. The major storage proteins in oats are globulins, while prolamins constitute minor proteins of oat. Oats typically contain 55-70% starch on a dry matter basis.

Recently, consumption of oats has increased remarkably. In addition to above mentioned health benefits, this may be due to the fact that compared to other grains oats is well-tolerated, even by those having celiac disease. A variety of new oat based food products have also been developed, including oat based meat substitutes, oat based beverages and dairy-free oat milk, the production of which has increased rapidly.

Oat milk or oat drink is produced by a process, wherein milled oat grains are soaked in water to extract their nutrients. Enzymes are typically used in the process to break down gelatinized oat starch into dextrins, which are then broken down into simpler sugars. The liquid fraction is separated from the solid by-product or residual fraction for example by decanting, filtration or centrifugation. The solid by-product or residual fraction from oat milk production, also called “oat okara”, is a protein and fiber rich fraction, which currently is used mainly in the production of animal feeds or energy. In the manufacture of oat milk, approximately 40-200 g (wet weight) of the above mentioned solid residual fraction or by-product is produced per 1 L of oat milk. Typically, the residual fraction from oat milk production has a dry matter content of 15-50% and a very low content of starch compared to wholegrain oats.

In WO 2020/240095 A1, an oat fraction, which may be a residual fraction from oat milk production, is suggested for use in texturised food products. However, further uses for the residual fraction from oat milk production and for any other oat fractions having a low starch content would be needed.

Hydrolyzed vegetable protein (HVP) products are typically used as flavour enhancers in processed foods, They are obtained by acid hydrolysis or enzymatic hydrolysis of vegetable proteins, such as corn, wheat, pea, soya and rice proteins. The enzymatic hydrolysis process often employs a mixture of endoproteases and exoproteases. However, enzymatic hydrolysis may not always be efficient enough in achieving levels of free glutamate needed for achieving the desired flavour or may be associated with problems in microbiological quality.

U.S. Pat. No. 9,259,018 B2 discloses a composition comprising a partially hydrolysed cereal protein, in particular wheat gluten. The composition can be used to produce protein supplemented food products for human consumption. U.S. Pat. No. 8,828,462 B2 relates to a method for preparing a proteinaceous vegetable flavour enhancer by two-stage enzymatic hydrolysis starting from a vegetable material, in particular wheat gluten or soya protein. The method yields a solubilized vegetable material, which can be used for flavouring or as a food additive. WO 2020/120737 A1 relates to a method for producing a flavour composition comprising free glutamate by contacting wheat gluten with a protease, with an exopeptidase and with a glutaminase to produce the flavour composition.

However, there exists a need for a method for preparing oat-based condiments, sauces and seasonings, which avoids the above-mentioned drawbacks and allows for efficient enzymatic hydrolysis of oat raw material. The method should also allow production of oat-based condiments with favourable flavour profile and avoid bacterial contamination and/or putrefaction. In particular, it would be advantageous to provide a method that employs oat raw material with a low starch content, such as the by-product from oat milk production.

### SUMMARY OF THE INVENTION

The invention is defined by the features of the independent claims. Some specific embodiments are defined in the dependent claims.

The present invention is based on the concept of using oat raw material having a starch content of 5% or less and a protein content of at least 24%, based on dry matter, for preparing oat-based savoury condiments by a process comprising pH adjustment, heat treatment, enzymatic treatment and at least one of high-pressure homogenization, microfluidization and wet milling. The enzymatic treatment employs at least one endopeptidase, at least one exopeptidase and glutaminase.

According to a first aspect of the present invention, there is provided a method for preparing oat-based condiments, the method comprising or consisting essentially of the steps of:
a) providing oat raw material having a starch content of 5% or less and a protein content of at least 24%, based on dry matter;
b) preparing an aqueous oat suspension of the oat raw material and, if necessary, adjusting the solids content of the aqueous oat suspension to 5-40%;
c) subjecting the aqueous oat suspension to heat treatment;
d) subjecting the heat treated aqueous oat suspension to at least one of high-pressure homogenization, microfluidization and wet milling;
e) cooling or allowing the aqueous oat suspension to cool to a temperature of 40-60° C.;
f) treating the aqueous oat suspension with enzymes comprising i) at least one endopeptidase, ii) at least one exopeptidase, and iii) glutaminase (EC 3.5.1.2);
g) inactivating the enzymes to obtain an enzyme-treated oat-based mass;
h) recovering the obtained oat-based mass for use as such or after seasoning as an oat-based savoury condiment; or
i) separating the obtained oat-based mass to a liquid part and to a solids part for use as oat-based condiments;
   wherein the method comprises before enzyme treatment
a step of adjusting the pH of the aqueous oat suspension to pH 4.0-6.2, or
a step of adjusting the pH of the aqueous oat suspension to pH 4.0-6.7 and optionally adding a salt in an amount of 3-30% by weight of the oat suspension.

According to a second aspect of the present invention, there is provided the use of the enzyme-treated oat-based mass obtained by the method of the invention as a savoury condiment or in the production of savoury condiments or other food products.

Embodiments of the invention comprise oat-based condiments obtainable by the method.

Considerable advantages are obtained by the invention. First, the method of the invention yields oat-based savoury condiments with umami-like odour and taste and good microbiological quality. In addition, the oat-based savoury condiments obtained by the method of the invention are stable and provide a smooth mouthfeel.

Further, in a preferred embodiment the invention employs a less utilized or even discarded residue of oat milk production in the preparation of value-added products. One of the advantages of using at least one of high-pressure homogenization, microfluidization and wet milling, together with enzyme treatment, is that, if so desired, the whole by-product from oat milk production may be used in the production of oat-based condiments, without separation of solids.

Further features and advantages of the present technology will appear from the following description of some embodiments.

### EMBODIMENTS

The present invention is based on the concept of using oat raw material having a starch content of 5% or less, based on dry matter, for preparing oat-based savoury condiments by a process comprising pH adjustment, heat treatment, enzymatic treatment and at least one of high-pressure homogenization, microfluidization and wet milling. Typically, the enzymatic treatment employs at least one endopeptidase, at least one exopeptidase and glutaminase.

“Condiments” include savoury seasonings, spices, sauces or preparations that are added to food, typically after cooking, to impart a specific flavour, to enhance the flavour, or to complement the dish. Condiments may be added during cooking to add flavour or texture, prior to serving, or may be served separately from the food and added to taste by the diner. In the present context, condiments typically include but are not limited to savoury sauces, pastes and the like.

### Oat Raw Material

In the present context, the term “oat raw material” comprises oat raw material having a starch content of 5% or less, preferably 4% or less, more preferably 3% or less, still more preferably 2% or less, based on dry matter. Further, the oat raw material has a protein content, which is at least 24%, preferably at least 30%, more preferably at least 40%, based on dry matter. In one embodiment, the oat raw material has a beta glucan content, which is 10% or less, preferably 5% or less, more preferably 2% or less, on a dry matter basis. Said oat raw material typically has a particle size D50 of 50-250 μm, preferably about 60-200 μm, more preferably 70-190 μm. Due to the low starch content, the term “destarched oats” may also be used for the raw material of the present invention.

Typically, the oat raw material for the purposes of the present invention is the by-product or residual fraction (oat okara) from the production of oat milk, oat beverages or liquid oat base, but any other oat fraction having the above-mentioned starch content is also applicable. The oat raw material may thus be for example any oat suspension comprising oats and water, where starch content has been reduced to 5% or less, based on dry matter, and wherein the protein content is at least 24%, based on dry matter.

As stated above, the oat raw material has a protein content of at least 24%, preferably at least 30%, more preferably at least 40%, based on dry matter. In some embodiments, the oat raw material has a fiber content of at least 5%, preferably at least 10%, more preferably at least 15%, based on dry matter.

“Particle size D50” refers to the median volume-weighted particle diameter when measured by laser diffraction. In practice, 50% of the particles in volume are smaller than the D50 value. Similarly, D10 and D90 values can be used to describe the particle size distribution of a product, where 10% or 90% of the particles are smaller than D10 or D90, respectively.

As stated above, the oat raw material may comprise or consist essentially of a residue or by-product from the production of oat milk, oat drink, other oat beverages or liquid oat base. As used herein “liquid oat base” refers to an oat based intermediate product, which may be used in the preparation of oat drinks, other oat based non-dairy products or e.g. oat drink powder. Suitable preparation methods of a liquid oat base are disclosed for example in WO 2020/025856 A1.

A residue or by-product obtained from the production of oat milk (oat okara) typically has a dry matter content of 20-40% but the dry matter content may vary, for example between about 15-50%. The above dry matter ranges relate to a “wet form” of the by-product, which typically is obtained directly from oat milk production. A “dry form” having a dry matter content of e.g. 90-97% may be obtained for example by flash-drying or mill drying the wet form.

The residue or by-product of oat milk production has a very low content of starch, typically 5% or less, preferably 4% or 3% less, more preferably 2% or less, based on dry matter. However, it is rich in fiber and proteins, typically having a protein content of at least 20%, preferably at least 30%, more preferably at least 40%, based on dry matter. Its fiber content is typically at least 5%, preferably at least 10%, more preferably at least 15%, based on dry matter. The beta-glucan content is rather low, typically 10% or less, preferably 5% or less, more preferably 2% or less, on a dry matter basis.

In embodiments of the invention, the oat raw material consists or consists essentially of a residue fraction or by-product from production of oat milk, oat drink, oat beverages, oat syrup or a liquid oat base, preferably from production of oat milk.

In a preferred embodiment, oat raw material is oat okara with a particle size D50 of 50-250 μm, preferably 60-200 μm, a protein content of at least 24%, preferably at least 30%, a starch content of 5% or less, preferably 2% or less, a beta-glucan content of 10% or less, preferably 5% or less, more preferably 2% or less, on a dry matter basis.

The oat raw material is prepared to the form of an aqueous suspension, which has a dry matter content of 5-40%, preferably about 10-30%, more preferably about 15-25%, typically about 20%. If necessary, a suitable dry matter content may be adjusted by adding water or a high-moisture or highly aqueous product, such as oat drink. A suitable dry matter content may vary according to the particular treatment(s) to be used in the step of subjecting the aqueous oat suspension to at least one of high-pressure homogenization, microfluidization and wet milling. For example, for high-pressure homogenisation a preferred dry matter content of the oat raw material feed is typically from at least about 9% to about 22%, such as 16-20%, wherein the oat raw material feed is preferably in the form of aqueous oat suspension.

Therefore, before subjecting the aqueous oat suspension to at least one of high-pressure homogenization, microfluidization and wet milling, the dry matter content of the oat raw material is adjusted to a desired level, if needed. Typically, this is achieved by mixing the oat raw material with water or a high-moisture (oat) product to form an aqueous suspension, which has a dry matter content of 5-40%, preferably about 10-30%, more preferably about 15-25%, still more preferably about 20%.

If needed, any soluble components may be separated from the oat raw material before at least one of high-pressure homogenization, microfluidization and wet milling. In an embodiment wherein the oat raw material comprises or is a residue fraction or by-product from oat milk production (oat okara), separation of the liquid fraction is typically carried out by decanting before a step of mixing the residue fraction with water to obtain an aqueous oat suspension with a desired dry matter content. However, other known separation methods such as filtration and centrifugation are also applicable and known to a person skilled in the art.

In an embodiment, the oat raw material has been subjected to at least one enzymatic treatment before the step of reducing its particle size. Preferably, the enzymatic treatment comprises at least treatment with amylases, in particular α-amylases.

In an embodiment wherein the oat raw material comprises or is a residue fraction from oat milk production, the enzymatic treatment is often included in the oat milk preparation process.

The oat raw material may also be combined with other raw materials before the subsequent process steps, in particular before the enzymatic treatment step. Such other raw materials may be selected from the group consisting of other oat fractions, such as oat bases, other protein sources, vegetable fats, hydrocolloid ingredients for food, vegetable starches, sweeteners, or the like.

### pH Adjustment and Optional Salt Content Adjustment

The method of the invention comprises a step of adjusting the pH of the aqueous oat suspension, in one embodiment to pH 4.0-6.2, preferably to about pH 4.0-5.0, more preferably to about pH 5. Alternatively, the method of the invention may comprise a step of adjusting the pH of the aqueous oat suspension to pH 4.0-6.7 and optionally adding a salt in an amount of 3-30% by weight of the oat suspension. In one or more embodiments, the method of the invention may comprise a step of adjusting the pH of the aqueous oat suspension to pH 4.0-6.7 and adding a salt in an amount of 3-30% by weight of the oat suspension. In one or more embodiments, the method of the invention may comprise a step of adding a salt in an amount of 3-30% by weight of the oat suspension, when the pH of the aqueous oat suspension is from pH 6.2 to pH 6.7.

The step of adjusting the pH is conducted before the enzymatic treatment step, typically before the heat treatment step.

Adjustment of pH may be carried out by acids and/or bases conventionally used in food industry. Typically, adjustment of pH is achieved by addition of an aqueous solution containing acids including but not limited to citric acid, phosphoric acid, acetic acid, sulphuric acid and nitric acid, or hydroxides of alkali metals and alkaline earth metals including but not limited to NaOH, KOH and Ca(OH)₂ and combinations thereof. In one embodiment, pH is adjusted by citric acid.

In some embodiments, the method of the invention may comprise a step of adding salt to the aqueous oat suspension. The amount of salt is typically 3-30%, preferably 4-20%, more preferably about 5% by weight of the aqueous oat suspension. A typical salt comprises NaCl but also other salts, such as KCl and MgCl may be applicable.

The step of adding salt to the aqueous oat suspension, if present, typically precedes the heat treatment step. In some embodiments, the salt addition step may be combined with the pH adjustment step.

Addition of salt may further enhance maintaining the microbiological quality of the product, in addition to heat treatments and pH adjustment.

### Heat Treatment

Before the step of reducing the particle size of the aqueous oat suspension by at least one of high-pressure homogenization, microfluidization and wet milling, the aqueous oat suspension is subjected to heat treatment. The heat treatment comprises heating the aqueous suspension to about 75-95° C., preferably to about 90° C., for a period of time, which is from 30 seconds to 1 hour, preferably about 10 minutes.

In a preferred embodiment, the heat treatment precedes the step of subjecting the aqueous oat suspension to at least one of high-pressure homogenization, microfluidization and wet milling.

In some embodiments, the heat treatment may comprise pasteurization and/or UHT treatment. Pasteurizing comprises heat treatment of the aqueous oat suspension, typically at about 80-90° C. for a few minutes. UHT (ultra-high temperature processing, ultra-heat treatment) typically comprises heat treatment above 135° C. for a few seconds, such as 2 to 5 seconds.

### High-Pressure Homogenization

In the present method, the aqueous oat suspension is subjected to at least one of high-pressure homogenization, microfluidization and wet milling. Said treatment reduces the particle size of the aqueous oat suspension. Typically, before applying at least one of high-pressure homogenization, microfluidization and wet milling the particle size of the aqueous oat suspension is 50-250 μm (D50), or 60-200 μm, such as 70-190 μm. According to a preferred method of the invention, after applying at least one of high-pressure homogenization, microfluidization and wet milling the obtained aqueous oat suspension has a particle size D50 of 5-<50 μm, preferably 5-30 μm.

In a preferred embodiment of the invention, the method according to the invention comprises at least the step of high-pressure homogenizing the aqueous oat suspension.

In the present context, high-pressure homogenization comprises homogenization at a pressure of at least 450 bar (45 MPa), preferably at a pressure of at least 700 bar (70 MPa). Typically the applied pressures in the high-pressure homogenization according to the method of the present invention are within a range of 450-1900 bar (45-190 MPa), preferably within a range of about 700-1000 bar, such as about 900 bar.

Both single-stage and double-stage high-pressure homogenizers may be used. In a double-stage or two-stage homogenizer, the pressure at the first stage is at least 450 bar, such as 450-1900 bar, preferably at least 700 bar, while the pressure in the second stage is about 20-300 bar, typically about 50-200 bar.

The step of high-pressure homogenizing may comprise several passes of the feed through a high-pressure homogeniser, such as 1-10 passes, preferably 1-3 passes, more preferably 1-2 passes. In preferred embodiments, one pass through the high-pressure homogenizer (either a single-stage or two-stage homogenizer) may be sufficient, when the operating pressure is at least 450 bar, typically about 700-1000 bar. It has been found that usual homogenization pressures, such as 100-250 bar, commonly used for example in dairy industry, are not sufficient for achieving the desired result starting from the aqueous oat suspension used in the present invention. Nevertheless, it has also been found that by using oat okara as raw material and by adjusting its dry matter content to at least 17% and using pressures of at least 300 bar, a suspension suitable for use in further steps of the process could be obtained.

The temperatures during high-pressure homogenization as well as during microfluidization may vary within a temperature range of +0-99° C., preferably 40-80° C., more preferably 50-70° C. Heating of the material before homogenization, such as pasteurization e.g. at about 80° C., does not have an effect on the homogenization result.

In some embodiments, the step of high-pressure homogenization may be followed by homogenization at a pressure of 20-300 bar, preferably at a pressure of 100-250 bar. In one embodiment, the process comprises the step of high-pressure homogenization, preferably with one pass through a high-pressure homogenizer, followed by homogenization at a lower pressure, typically at a pressure of 20-300 bar. Alternatively, homogenization at a pressure of 20-300 bar may precede the high-pressure homogenization.

The dry matter content of the aqueous oat suspension before high-pressure homogenization is adjusted to 5-40%, preferably about 10-30%, more preferably about 15-25%, typically about 20%, if not already within the mentioned ranges.

Typically, high-pressure homogenization does not essentially change the viscosity of the aqueous oat suspension feed, which has a dry matter content of 5-40%, preferably about 10-30%, more preferably about 15-25%, typically about 20%, although the particle size decreases.

### Microfluidization

In one embodiment of the invention, the method according to the invention comprises at least the step of microfluidizing the aqueous oat suspension. Microfluidization applies high dynamic pressure to a suspension, reducing its particle size. In microfluidization, a suspension is pumped through a fixed geometry interaction chamber where it is subjected to high shear rates and impact forces. Different chamber configurations are available and can be used in combinations.

Typically, applied microfluidization pressures in the method of the present invention are within a range of 100-2100 bar, preferably within a range of about 1000-1500 bar. The step of microfluidization may comprise several passes of the raw material through a microfluidization chamber, such as 1-10 passes, preferably 1-3 passes, more preferably 1-2 passes.

The step of microfluidization may also be combined with high-pressure homogenization, wet milling, or both.

### Wet Milling

Generally, in wet milling or wet grinding process a product is wet-milled in the presence of solvents, such as water, and possibly different pH values, typically to disintegrate insoluble structures and reduce particle size. Wet milling can be used to separate grains into their main components, for example to produce protein concentrates, starch and residue fractions. In the present context, wet milling refers to treatment of the oat raw material, in particular the aqueous oat suspension, by an ultra-fine friction grinder equipped with two ceramic grinding stones. Typically, applied gap in the method of the present invention are within a range of 0.05-5 micrometers, preferably in the range of 0.1-0.3 micrometres. The step of wet milling may comprise several passes of the suspension through the milling unit, such as 1-10 passes, preferably 1-3 passes, more preferably 1-2 passes.

In some embodiments, at least two of the above-disclosed processing technologies may be combined. In one preferred embodiment, the step of wet milling the aqueous oat suspension is followed by microfluidization or high-pressure homogenisation, preferably microfluidization. The combination of wet milling and microfluidization or high-pressure homogenization results in a smaller D50 particle size than wet milling alone, which may have advantages such as improved mouthfeel in end applications.

In some embodiments, in particular when the oat starting material is the dry form of the by-product from oat milk production, wet milling may be replaced with dry milling, followed by microfluidization or high-pressure homogenization.

### Enzymatic Treatment

As stated above, the method for preparing oat-based condiments comprises a step, wherein the aqueous oat suspension is treated with enzymes, wherein said enzymes comprise i) at least one endopeptidase, ii) at least one exopeptidase, and iii) glutaminase (EC 3.5.1.2).

Therefore, after subjecting the aqueous oat suspension to at least one of high-pressure homogenization, microfluidization and wet milling, the suspension is cooled or allowed to cool to a temperature, which is suitable for the action of the chosen enzymes. Typically, said temperature is 40-60° C., preferably about 50° C., depending on the nature of the enzymes used.

Before enzymatic treatment the pH of the aqueous oat suspension has been adjusted as indicated above. In some embodiments the step of adjusting the pH is performed before heat treatment. Adjustment of pH is achieved by addition of solutions containing acids or bases known to persons skilled in the art as explained above.

Endopeptidases break peptide bonds within the molecule, i.e. they break peptide bonds of nonterminal amino acids. Endopeptidases are preferably selected from the group comprising serine endopeptidases, cysteine endopeptidases, aspartic endopeptidases, metallo-endopeptidases, proline-specific endopeptidases, more preferably from the group consisting of serine endopeptidases, aspartic endopeptidases and proline-specific endopeptidases.

Exopeptidases are able to break down proteins further into amino acids, since they break peptide bonds from terminal amino acids. Exopeptidases are preferably selected from aminopeptidases, carboxypeptidases, dipeptidases, dipeptidyl-peptidases, and tripeptidyl-peptidases, more preferably from aminopeptidases and carboxypeptidases.

The process is preferably conducted using at least one endopeptidase and at least one exopeptidase. However, a protease preparation having both endo and exo protease properties may also be used.

The enzymes also include glutaminase. Glutaminase (EC 3.5.1.2) is able to catalyse the generation of glutamate from glutamine. The enzyme thus converts glutamine to glutamate, with the release of ammonia.

The appropriate dosage of enzymes can vary over a wide range. Typically, the enzyme dosage based on the total weight of the aqueous oat suspension is between 0.001% and 1%, for example about 0.1% by weight. The enzymes may be dosed in a single addition or a number of additions, preferably in a single addition, more preferably as a mixture of enzymes, wherein the enzyme mixture contains endopeptidase, exopeptidase and glutaminase activity. The enzyme dosage and/or the incubation time are adjusted according to the enzymes used.

Some non-exhaustive examples of enzymes that can be used in the present invention include Umamizyme® Pulse, which contains a mixture of endopeptidase, exopeptidase and glutaminase activity.

The enzymes and the aqueous oat suspension are incubated at the above mentioned temperatures of the enzymatic reaction. The enzymes may subsequently be inactivated. Preferably, inactivation of enzymes is carried out 4-24 hours, such as 16-24 hours, after adding the enzymes in the aqueous oat suspension, typically by heat treatment, for example by heating the suspension to about 90° C.

### Oat-Based Condiments

After enzymatic treatment and inactivation of enzymes the obtained oat-based mass is recovered. The obtained product has a smooth mouthfeel and a pleasant savoury, umami-like taste due to the formation of glutamate during the process.

Therefore, in one embodiment, said oat-based mass may be used as such or after seasoning as an oat-based savoury condiment.

Alternatively, the obtained oat-based mass may be separated to a liquid part and to a solids part. The liquid part may be used as such or after seasoning as an oat-based savoury condiment. The solids part may be used as such or after seasoning as a miso type paste.

In an embodiment wherein the oat-based mass is separated to a liquid part and to a solid part, the separation step is preferably centrifugation but may, in addition or alternatively, be decantation, filtration, membrane filtration or other separation processes known to the skilled person, or combinations thereof.

The obtained oat-based mass typically has a dry matter content of 5-40%, preferably about 10-30%, more preferably about 15-25%, typically about 20%. The dry matter content of the oat-based mass does not thus essentially differ from the dry matter content of the aqueous oat suspension before subjecting the suspension to at least one of high-pressure homogenization, microfluidization and wet milling and to enzymatic treatment.

The obtained oat-based products find use as savoury condiments (seasonings, spices, sauces, pastes etc.) for adding to food, typically after cooking, to impart a specific flavour, to enhance the flavour, or to complement the dish. The obtained oat-based products may also be included in various food or beverage products during preparation process thereof.

The invention also relates to the use of the enzyme-treated oat suspension obtained by the method of the invention as a savoury condiment or in the production of savoury condiments or other food products, and to oat-based condiments obtainable by the method of the invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

### EXPERIMENTAL

Unless otherwise stated, properties that have been experimentally measured or determined herein have been measured or determined at room temperature. Unless otherwise indicated, room temperature is 25° C. Unless otherwise stated, properties that have been experimentally measured or determined herein have been measured or determined at atmospheric pressure.

“Particle size D50” refers to the median volume-weighted particle diameter when measured by laser diffraction. In practice, 50% of the particles in volume are smaller than the D50 value. Similarly, D10 and D90 values can be used to describe the particle size distribution of a product, where 10% or 90% of the particles are smaller than D10 or D90, respectively.

Protein analysis refers to Kjeldahl total nitrogen analysis (nitrogen to protein conversion factor 6.25). Starch analysis refers to a spectrophotometric method, wherein starch is solubilized using DMSO and converted to glucose by amyloglucosinase enzyme. Glucose quantification is carried out using hexokinase method.

Fibre analysis refers to enzymatic-gravimetric analysis of dietary fibre using the method AOAC 991.43 Mod.

Dry matter analysis refers to gravimetric analysis of moisture using the method NMKL 23:1991, mod.

### EXAMPLE 1. CONDIMENT SAUCE FROM WET RAW MATERIAL BY HPH

A destarched oat raw material comprising approx. 50% protein, 2% starch and 1.4% betaglucan on dry matter basis, having a D50 particle size of 188 μm, was diluted with water to 20% dry matter content. Sample pH was adjusted to 5 with citric acid to prevent microbial spoilage. Sample was heated up to 90° C. and subjected to 2-stage high-pressure homogenizer. Operating pressure was 900/100 bar. Mass was cooled to 50° C. for enzyme treatments. Umamizyme® Pulse 0.1% from total mass was added and reaction time at 50° C. was 24 h. After enzyme treatment the mass was heated up to 90° C. to inactivate enzymes. Obtained mass can be used as such or as flavouring for all kind of savoury products. Obtained mass can be also separated to liquid part and to a solids part.

### EXAMPLE 2. CONDIMENT SAUCE FROM DRY RAW MATERIAL BY HPH

A destarched oat raw material comprising approx. 50% protein, 2% starch and 1.4% betaglucan on dry matter basis, having a D50 particle size of 73 μm, was diluted with water to 20% dry matter content. Sample pH was adjusted to 5 with citric acid to prevent microbial spoilage. Sample was heated up to 90° C. and subjected to 2-stage high-pressure homogenizer. Operating pressure was 900/100 bar. Mass was cooled to 50° C. for enzyme treatments. Umamizyme® Pulse 0.1% from total mass was added and reaction time at 50° C. was 24 h. After enzyme treatment the mass was heated up to 90° C. to inactivate enzymes. Obtained mass can be used as such or as flavouring for all kind of savoury products. Obtained mass can be also separated to liquid part and to a solids part.

### EXAMPLE 3. WET MILLING AND MICROFLUIDIZATION OF OAT RAW MATERIAL (WET FORM)

A destarched oat raw material (wet form) comprising approx. 50% protein, 2% starch and 1.4% beta-glucan on dry matter basis, having a D50 particle size of 188 μm, was diluted with water to 20% dry matter content. Sample pH was adjusted to 5 with citric acid to prevent microbial spoilage. Sample was heated up to 60° C. and subjected to wet milling using an ultra-fine friction grinder equipped with two grinding stones made of aluminium oxide and resins. The raw material was diluted with water to 10% dry matter content and passed through the mill twice at a rotation speed of 1500 rpm. Gap width 25 between the grinding stones was 0.2-0.22 mm during the first pass and 0.25 mm during the second pass, respectively. The wet-milled raw material was additionally subjected to microfluidization using two passes. Operating pressure was 1000 bar during the first pass and 1500 bar during the second pass, respectively, and chamber combinations were 400+200 μm. Mass was cooled to 50° C. for enzyme treatments. Umamizyme® Pulse 0.1% from total mass was added and reaction time at 50° C. was 24 h. After enzyme treatment the mass was heated up to 90° C. to inactivate enzymes. Obtained mass can be used as such or as flavouring for all kind of savoury products. Obtained mass can be also separated to liquid part and to a solids part.

### EXAMPLE 4. EFFECT OF SALT AND PH ON MICROBIOLOGICAL QUALITY

A destarched oat raw material comprising approx. 50% protein, 2% starch and 1.4% betaglucan on dry matter basis, having a D50 particle size of 188 μm, was diluted with water to 20% dry matter content. Sample pH before pH adjustments was 6.7. The pH and salt content of the samples were adjusted according to Table 1 by using citric acid and NaCl. Sample was heated up to 90° C. and subjected to 2-stage high-pressure homogenizer. Operating pressure was 900/100 bar. Mass was cooled to 50° C. for enzyme treatments. Umamizyme® Pulse 0.1% from total mass was added and reaction time at 50° C. was 24 h. After enzyme treatment the mass was heated up to 90° C. to inactivate enzymes. Umamizyme® Pulse optimum pH range is 4.0-5.0 which explains umami odour intensity results on Table 1.

TABLE 1
Effect of salt and pH on microbiological quality

| Sam- | Adjusted | Added | Microbiological quality after 24 h |
|---|---|---|---|
| ple | pH | NaCl (%) | enzyme treatment at +50° C. |
| 1 | 6.7 | 0 | Microbiologically spoiled, yeast like odour |
| 2 | 6.2 | 0 | Microbiological quality good, mild umami |
| | | | like odour and taste |
| 3 | 5.7 | 0 | Microbiological quality good, mild umami |
| | | | like odour and taste |
| 4 | 5.2 | 0 | Microbiological quality good, strong |
| | | | umami like odour and taste |
| 5 | 4.7 | 0 | Microbiological quality good, strong |
| | | | umami like odour and taste |
| 6 | 4.2 | 0 | Microbiological quality good, strong |
| | | | umami like odour and taste |
| 7 | 6.7 | 5 | Microbiological quality good, mild umami |
| | | | like odour and taste |
| 8 | 5 | 5 | Microbiological quality good, strong |
| | | | umami like odour and taste |

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in food industry, typically in the preparation of condiments (seasonings, spices, sauces, pastes etc.) for adding to food, typically after cooking, to impart a specific flavour, to enhance the flavour, or to complement the dish.

### CITATION LIST

### Patent Literature

U.S. Pat. No. 8,828,462 B2
U.S. Pat. No. 9,259,018 B2
WO 2020/025856 A1
WO 2020/120737 A1
WO 2020/240095 A1

1. A method for preparing an oat-based condiment, comprising:
a) providing an oat raw material having a starch content of 5% or less and a protein content of at least 24%, based on dry matter;
b) preparing an aqueous oat suspension of the oat raw material and, if the solids content of the aqueous oat suspension is not already at 5-40%, adjusting the solids content of the aqueous oat suspension to 5-40%;
c) subjecting the aqueous oat suspension to heat treatment;
d) subjecting the heat-treated aqueous oat suspension to at least one of high-pressure homogenization, microfluidization, or wet milling;
e) cooling or allowing the aqueous oat suspension to cool to a temperature of 40-60° C.;
f) treating the aqueous oat suspension with enzymes comprising: i) at least one endopeptidase, ii) at least one exopeptidase, and iii) glutaminase (EC 3.5.1.2);
g) inactivating the enzymes after adding the enzymes, to obtain an enzyme-treated oat-based mass; and
h) recovering the obtained enzyme-treated oat-based mass or separating the obtained enzyme-treated oat-based mass to a liquid part and to a solids part;
wherein the method further comprises, before the enzyme treatment:
adjusting the pH of the aqueous oat suspension to pH 4.0-6.2, or
adjusting the pH of the aqueous oat suspension to pH 4.0-6.7, and optionally adding a salt in an amount of 3-30%, by weight of the aqueous oat suspension.

2. The method according to claim 1, wherein the method further comprises adjusting the pH of the aqueous oat suspension to pH 4.0-6.2.

3. The method according to claim 1, further comprising adjusting the pH of the aqueous oat suspension to pH 4.0-6.7 and adding a salt in an amount of 3-30%, by weight of the aqueous oat suspension.

4. The method according to claim 1, wherein the oat raw material has a particle size D₅₀ of 50-250 μm.

5. The method according to claim 1, where wherein the oat raw material has a protein content of at least 30%, preferably at least 40%, based on dry matter.

6. The method according to claim 1, wherein the oat raw material has a fiber content of at least 5%, based on dry matter.

7. The method according to claim 1, wherein the oat raw material has a beta-glucan content of 10% or less, based on dry matter.

8. The method according to claim 1, wherein the oat raw material is an aqueous oat suspension treated with amylases.

9. The method according to claim 1, wherein the oat raw material comprises or is a residue fraction or by-product from the production of oat milk, oat drink, an oat beverage, oat syrup, or a liquid oat base.

10. The method according to claim 1, wherein the oat raw material is a by-product from the production of oat milk and has a dry matter content of 15-50% (wet form) or 90-97% (dry form), and wherein, if necessary the dry matter of the oat raw material is not already at 5-40%, the method further comprises a step of adjusting the dry matter content of the oat raw material to obtain an aqueous oat suspension having a dry matter content of 5-40%.

11. The method according to claim 1, wherein the heat treatment comprises heating the aqueous suspension to about 75-95° C., for a period of time from 30 seconds to 1 hour.

12. The method according to claim 1, further comprising high-pressure homogenizing the oat raw material at a pressure of at least 450 bar (45 MPa).

13. The method according to claim 12, wherein the high-pressure homogenization comprises 1-10 passes of the oat raw material through a high-pressure homogenizer.

14. The method according to claim 1, wherein the method comprises subjecting the heat-treated aqueous oat suspension to microfluidization.

15. The method according to claim 1, further comprising wet milling the oat raw material, optionally followed by microfluidization.

16. The method according to claim 1, wherein, after step e), the aqueous oat suspension has a particle size D₅₀ of 5-<50 μm.

17. The method according to claim 1, wherein the at least one endopeptidase is selected from the group consisting of serine endopeptidases, cysteine endopeptidases, aspartic endopeptidases, metallo-endopeptidases, and proline-specific endopeptidases.

18. The method according to claim 1, wherein the at least one exopeptidase is selected from the group consisting of aminopeptidases, carboxypeptidases, dipeptidases, dipeptidyl-peptidases, and tripeptidyl-peptidases.

19. The method according to claim 1, wherein the method comprises;
separating the obtained enzyme-treated oat-based mass to a liquid part and to a solids part;
recovering the liquid part and using it, optionally after seasoning, as a savoury sauce;
recovering the solids part and using it, optionally after seasoning, as a miso-like paste.

20. (canceled)

21. An oat-based condiment obtained by the method according to claim 1.
